(19) United States
(12) Patent Application Publication
(10) Pub. No.: US 2010/0221982 A1
(43) Pub. Date: Sep. 2, 2010

(54) KIT HAVING TWO TYPES OF CLAY

(75) Inventors: William R. Andrichik, Dallas, TX (US); Mohsen S. Marzouk, Flower Mound, TX (US)

Correspondence Address: Setter Roche LLP, P.O. Box 780, Erie, CO, 80516, US

(73) Assignee: Illinois Tool Works Inc., Glenview, IL (US)

(21) Appl. No.: 12/394,840

(22) Filed: Feb. 27, 2009

(51) Int. Cl. B24B 1/00; C09K 3/14

(52) U.S. Cl. 451/28; 51/298

(57) ABSTRACT

A customizable sanding clay kit in accordance with the principles of the invention includes an aggressive flexible sanding composite and a mild flexible sanding composite. The aggressive flexible sanding composite may have a level of coarseness approximately equal to sandpaper grit of between about 600 and about 800, while the mild flexible sanding composite may have a level of coarseness approximately equal to sandpaper grit of between about 2,000 and about 2,500. The invention also includes a method of removing dirt or contamination from a surface, or flattening surface irregularities, which includes kneading together selected amounts of the aggressive flexible sanding composite and the mild flexible sanding composite to achieve a combined flexible sanding composite, and rubbing the combined flexible sanding composite against the surface repeatedly until the dirt or contamination is diminished, or until the surface irregularities are flattened.

### FIELD OF THE INVENTION

This invention relates to a kit containing at least two types of flexible sanding composite that can be combined in varying amounts to achieve a preferred level of coarseness for use in removing dirt and contamination from a surface, as well as smoothing or flattening hard surface irregularities as found on such surfaces as painted automotive finishes, granite tops, marine gel coats, or any other coated, painted, or unpainted, hard or composite surface.

### BACKGROUND OF THE INVENTION

For centuries, sandpaper and abrasive-impregnated emery cloth papers have been the tools of choice for removing small layers of material, such as dirt and contamination, and leveling irregularities from surfaces. Sandpaper can also make the surface smoother or rougher. The flexibility of a paper backing allows sandpaper to follow irregular or rounded contours of virtually any surface shape, with limitations. Numerous motor-driven devices have been developed to facilitate the handling of sandpaper, such as belt sanders, detail sanders, disc sanders, palm sanders, and orbit sanders.

Despite the development of these sanding devices, sandpaper is still commonly used by hand for both small touch-up areas as well as large areas. Sanding a surface by hand, as opposed to using a motor-driven sanding device, provides the user with complete control over the amount of pressure applied and the exact location to which the abrasive material is applied.

A variety of sanding blocks provide a handle in order to more easily grip the sandpaper. The most basic type of sanding block is essentially a block of wood or other hard material around which sandpaper can be wrapped, thus providing a handle for gripping the sandpaper while sanding a surface. Once the sandpaper has become worn in at least one area, the position of the sandpaper can be adjusted on the block in order to utilize other lesser-used areas of the sandpaper. Such sanding blocks are often more comfortable to use than sandpaper alone, but these blocks typically lack the flexibility needed to follow irregular, contoured, or narrow surfaces, which results in uneven pressure being applied to such surfaces and, consequently, uneven sanding.

Some sanding blocks are integral with the sandpaper, such as sponge-backed sanding blocks. These sponge-backed sanding blocks provide a handle and the sponge backing maintains sufficient flexibility to allow the sandpaper to follow the contours of the surface being sanded. One drawback of these sponge-backed sanding blocks is that the surfaces of abrasive material are prone to uneven wear. That is, the abrasive material may wear off on certain areas of the sanding block while other less-frequently-used areas of the sanding block remain intact. However, the less-frequently-used areas may experience less usage because their locations are impractical or uncomfortable for the user. Thus, the sponge-backed sanding block is typically discarded after only a fraction of the abrasive material has worn off.

Each of the sanding devices described above has a set level of coarseness. Different projects often require different levels of coarseness. Consequently, a user may need to buy multiple sanding devices, or at least multiple types of sandpaper that vary in grit, in order to meet all of his or her sanding needs. Professional tradesmen as well as occasional handymen could end up with a considerable stockpile of partially-used sandpaper and/or sanding devices.

There is a need or desire for a sanding device for use in removing dirt and contamination from a surface, particularly from a painted metal surface, and to smooth and/or flatten uneven, irregular surfaces. There is a further need or desire for a sanding device capable of applying even pressure along the surface being sanded. There is yet another need or desire for a sanding device that can be used repeatedly without uneven wear.

There is a further need or desire for a kit that allows a user to customize a sanding device to achieve a desired level of coarseness, particularly such a kit that enables the sanding device to be readjusted to different levels of coarseness after one or more uses.

### SUMMARY OF THE INVENTION

A customizable sanding clay kit in accordance with the principles of the invention may be in the form of an aggressive flexible sanding composite and a separate mild flexible sanding composite. The aggressive flexible sanding composite may have a level of coarseness approximately equal to sandpaper grit of between about 600 and about 800, and the mild flexible sanding composite may have a level of coarseness approximately equal to sandpaper grit of between about 2,000 and about 2,500.

In particular, the aggressive flexible sanding composite may include about 10% to about 70% by weight liquid component, about 30% to about 85% by weight abrasive material, and about 0% to about 5% by weight synthetic rubber. The liquid component may include polybutene and/or oleic acid, for example. The abrasive material may include calcium carbonate and/or aluminum oxide, for example. The abrasive material suitably has an average particle size between about 1 and about 50 micrometers (pm). The synthetic rubber may include butyl rubber, cross-linked butyl rubber, or combinations thereof.

The mild, or non-abrasive, flexible sanding composite may include about 10% to about 80% by weight liquid component, about 0% to about 80% by weight abrasive material, and about 0% to about 5% by weight synthetic rubber. The liquid component may include polybutene and/or oleic acid, for example.

The aggressive flexible sanding composite and the mild flexible sanding composite may each include less than 1% by weight color pigment, thus giving each flexible sanding composite a distinct color. The kit may also include a color chart that indicates different colors of flexible sanding composite associated with different levels of coarseness.

A method of removing dirt or contamination from a surface, or flattening surface irregularities, in accordance with the principles of the invention, includes selecting an amount of the aggressive flexible sanding composite, selecting an amount of the mild flexible sanding composite, kneading together the selected amounts of the aggressive flexible sanding composite and the mild flexible sanding composite to achieve a combined flexible sanding composite, and rubbing the flexible sanding composite against the surface repeatedly until the dirt or contamination is diminished and the rubbed surface is level and flat in relation to the surrounding un-touched surfaces.

The method may include adding more of the aggressive flexible sanding composite and/or more of the mild flexible sanding composite to adjust the level of coarseness of the combined flexible sanding composite. This adjustment may be made at any time, such as before using the combined flexible sanding composite on any surface, or after using the combined flexible sanding composite on one or more surfaces. In kits containing a color chart indicating colors associated with levels of coarseness, the selected amounts of the aggressive and mild flexible sanding composites can be adjusted to achieve the combined flexible sanding composite having a color that corresponds to a desired level of coarseness.

In certain embodiments, the method includes applying a lubricant to the surface prior to rubbing the surface with the flexible sanding composite. The surface may be a surface on a vehicle or a surface on industrial machinery, for example.

This invention will become more fully understood from the following detailed description, taken in conjunction with the accompanying drawings described herein below, and wherein like reference numerals refer to like parts.

### BRIEF DESCRIPTION OF THE DRAWINGS

FIG. 1 illustrates a package containing a customizable sanding clay kit.

FIG. 2 illustrates a combined flexible sanding composite applied to a surface.

### DESCRIPTION OF PREFERRED EMBODIMENTS

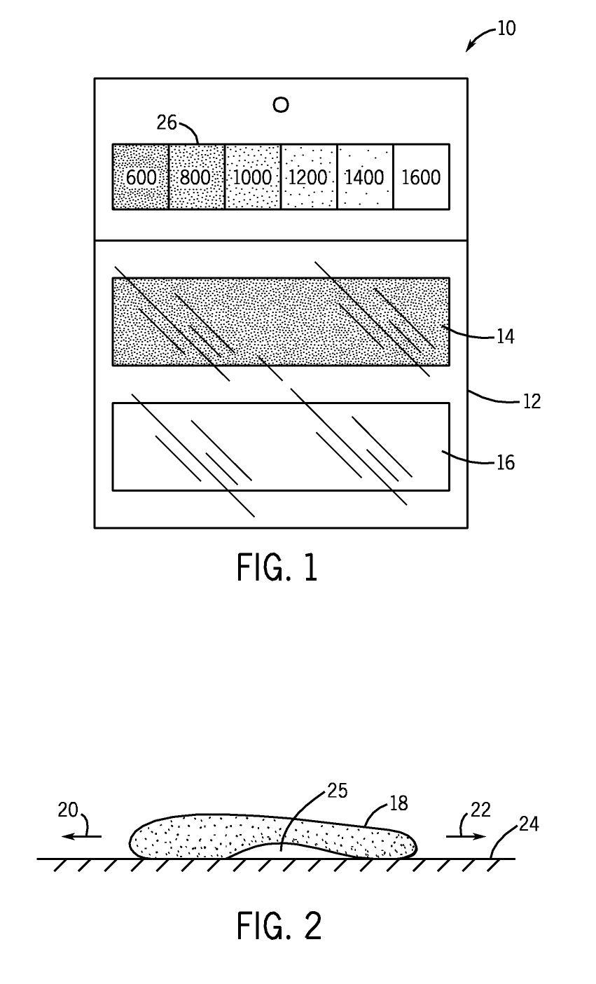

A package 12 containing a customizable sanding clay kit 10 is illustrated in FIG. 1. The kit 10 includes an aggressive flexible sanding composite 14 and a mild flexible sanding composite 16. Various proportions of each of these flexible sanding composites 14 and 16 can be kneaded together to achieve a combined flexible sanding composite 18 having a desired level of coarseness. The combined flexible sanding composite 18 is illustrated in FIG. 2, with arrows 20 and 22 indicating how the combined flexible sanding composite 18 can be rubbed against a surface 24 repeatedly to remove dirt or contamination 25 from the surface 24, or to flatten surface irregularities. The surface 24 may be a surface on a vehicle, or a surface on industrial machinery, or virtually any other hard surface such as granite tops, marine gel coats, or other coated, painted, or unpainted hard or composite surfaces.

The variability of the coarseness renders the combined flexible sanding composite 18 suitable for use on a wide variety of surfaces, including clear-coated paint surfaces or metal. Furthermore, because of the potentially broad range of coarseness, the combined flexible sanding composite 18 can be used as either a polishing clay that is lightly-abrasive or non-abrasive for use in cleaning the surface of vehicles or the like, or as a sanding clay that is highly abrasive for use in body shop preparation of vehicles or in heavy-duty industrial cleaning applications.

The convenience of providing two or more grades of flexible sanding composite in a kit 10 provides a user with a variety of options. For example, instead of buying multiple grades of sandpaper, with a single kit 10 the user can: (1) use the aggressive flexible sanding composite 14 for sanding, cleaning, and other heavy-duty applications in which scratching and marring is inconsequential, (2) use the mild flexible sanding composite 16 for polishing, cleaning, or other non-abrasive needs, (3) combine the aggressive flexible sanding composite 14 and the mild flexible sanding composite 16 for virtually any application that falls anywhere between the mild and aggressive levels of coarseness, and/or (4) progressively add more of either flexible sanding composite during a single sanding project. For instance, when “going through the grits,” or sanding a project that involves using progressively finer pieces of sandpaper to get a smooth finish, rather than switching to different pieces of sandpaper, this kit 10 can be used to carry out each progressive stage of sanding by gradually adding more of the mild flexible sanding composite 16 to the combined flexible sanding composite 18 until the sanding project is complete.

The aggressive flexible sanding composite 14 and the mild flexible sanding composite 16 may each include a color pigment, such as less than 1% by weight color pigment, thus giving each flexible sanding composite a distinct color. As illustrated in FIG. 1, the kit 10 may also include a color chart 26 that indicates different colors or shades of the combined flexible sanding composite 18 associated with different levels of coarseness. For example, the aggressive flexible sanding composite 14 may be dark gray while the mild flexible sanding composite 16 may be light gray or white. The corresponding color chart 26 may provide a range of shades of gray and the corresponding level of coarseness associated with various shades. The levels of coarseness may be assigned a number that corresponds to a specific sandpaper grit, or may simply indicate the coarseness as “coarse,” “medium,” “fine,” “very fine,” or the like.

Sandpaper grit refers to the number of abrasive particles per square inch of sandpaper. Lower grit numbers correspond to larger-sized abrasive particles and, thus, greater coarseness. Conversely, higher grit numbers correspond to smaller-sized abrasive particles and, thus, smoother sandpaper.

The particle sizes of abrasive material included in the aggressive flexible sanding composite 14 and in the mild flexible sanding composite 16 may vary in accordance with a desired level of coarseness. An average particle size is determined by measuring the particles across their greatest diameter for both regular-shaped particles and irregular-shaped particles. In general, the abrasive material may have an average particle size between about 1 and about 50 micrometers (μm).

Because the flexible sanding composites have more of a clay substrate than a paper substrate, compared to sandpaper, the coarseness of the flexible sanding composites is dependent on the average particle size of the abrasive material as well as the concentration of the abrasive material. For instance, the aggressive flexible sanding composite 14 may include abrasive material having an average particle size between about 10 and about 50 μm, and correspondingly may have a level of coarseness approximately equal to sandpaper grit of between about 600 and about 800. In contrast, the mild flexible sanding composite 16 may include an abrasive material having an average particle size between about 1 and about 20 μm, but may have a level of coarseness approximately equal to sandpaper grit of between about 2,000 and about 2,500 due to the lower concentration of the abrasive material, as described below.

The aggressive flexible sanding composite 14 suitably includes about 30% to about 85% by weight abrasive material. In certain embodiments, the aggressive flexible sanding composite 14 may include 50% to about 85% by weight abrasive material, or 70% to about 85% by weight abrasive material. The abrasive material may include 1% to 100% by weight calcium carbonate, or 90% to 100% by weight calcium carbonate. Additionally or alternatively, the abrasive material may include 1% to 100% by weight aluminum oxide, or 0% to 15% by weight aluminum oxide. In certain embodiments, the abrasive material may include both calcium carbonate and aluminum oxide. An example of a commercially-available calcium carbonate is Gamaco®, available from inerys Performance Minerals of Roswell, Ga. An example of a commercially-available aluminum oxide is polishing grade alumina, available from Alcoa of Pittsburgh, Pa. Other types of suitable abrasive material may include, for example, garnet, silicon carbide, or ceramic materials.

The mild flexible sanding composite 16 suitably includes about 0% to about 80% by weight abrasive material. The abrasive material may include 1% to 100% by weight calcium carbonate, or 40% to 80% by weight calcium carbonate. Additionally or alternatively, the abrasive material may include 1% to 100% by weight aluminum oxide, or 0% to 30% by weight aluminum oxide. As in the aggressive flexible sanding composite 14, the abrasive material may include both calcium carbonate and aluminum oxide. Other types of suitable abrasive material may include, for example, garnet, silicon carbide, or ceramic materials.

The aggressive flexible sanding composite 14 also includes about 10% to about 70% by weight liquid component. In certain embodiments, the aggressive flexible sanding composite 14 may include 12% to about 50% by weight liquid component, or 15% to about 25% by weight liquid component. The liquid component may include 1% to 100% by weight polybutene, or 1% to 60% by weight polybutene, or 8% to 55% by weight polybutene. Additionally or alternatively, the liquid component may include 1% to 100% by weight oleic acid, or 1% to 60% by weight oleic acid, or 5% to 55% by weight oleic acid. In certain embodiments, the liquid component may include both polybutene and oleic acid. The liquid component may include either high molecular weight polybutene, or low molecular weight polybutene, or a mixture of high and low molecular weight polybutene, depending on the intended use of the aggressive flexible sanding composite 14. The different molecular weights of polybutene provide different consistencies. For example, a high molecular weight polybutene having a molecular weight of 18,000, for example, provides a consistency comparable to hard, flexible rubber. In contrast, a low molecular weight polybutene having a molecular weight of 100, for example, provides a consistency comparable to soft, flexible rubber. Thus, by combining these two different types of polybutene, a consistency anywhere between these two types can be achieved. One example of a commercially-available high molecular weight polybutene is Indopol® H-18,000, available from INEOS of League City, Tex. One example of a commercially-available low molecular weight polybutene is Indopol® H-100, also available from INEOS. An example of a commercially-available oleic acid is Emersol® 213, available from Cognis Oleochemicals of Cincinnati, Ohio.

Similarly, the mild flexible sanding composite 16 suitably includes about 10% to about 80% by weight liquid component. In certain embodiments, the mild flexible sanding composite 16 may include 15% to about 50% by weight liquid component, or 18% to about 23% by weight liquid component. The liquid component may include 1% to 100% by weight polybutene, or 1% to 60% by weight polybutene, or 8% to 55% by weight polybutene. Additionally or alternatively, the liquid component may include 1% to 100% by weight oleic acid, or 1% to 65% by weight oleic acid, or 5% to 55% by weight oleic acid. In certain embodiments, the liquid component may include both polybutene and oleic acid. As in the aggressive flexible sanding composite 14, the liquid component may include either high molecular weight polybutene, or low molecular weight polybutene, or a mixture of high and low molecular weight polybutene, depending on the intended use of the mild flexible sanding composite 16.

The aggressive flexible sanding composite 14 also includes about 0% to about 5% by weight synthetic rubber. The synthetic rubber may include butyl rubber, cross-linked butyl rubber, or combinations of these materials. The synthetic rubber is typically added to the liquid component and the abrasive material in the form of pellets. When the pellets are heated, the pellets melt and encase the other materials within the aggressive flexible sanding composite 14, particularly the abrasive material. The aggressive flexible sanding composite 14 can be formed through an extrusion process, resulting in a relatively thin shape, if so desired. Likewise, the mild flexible sanding composite 16 also includes about 0% to about 5% by weight synthetic rubber.

Both the aggressive flexible sanding composite 14 and the mild flexible sanding composite 16, as well as the combined flexible sanding composite 18, may have the consistency of hydrated clay, but the flexible sanding composites do not necessarily include any clay materials, such as bentonite or kaolinite. This consistency allows the user to mold and shape the flexible sanding composites, as well as to knead the composites to bring up a fresh sanding (abrasive) surface, which provides extended use of the flexible sanding composites without uneven wear. Additionally, this consistency allows the user to shape the flexible sanding composites into virtually any shape, including flat, to accommodate the user's preference, thus allowing quicker completion of a project.

As described above, the customizable sanding clay kit 10 can be used to remove dirt or contamination 25 from a surface 24, or to flatten surface irregularities, or to simply smooth the finish. More specifically, a user may select an amount of the aggressive flexible sanding composite 14 and an amount of the mild flexible sanding composite 16, and then knead together the selected amount of the aggressive flexible sanding composite 14 with the selected amount of the mild flexible sanding composite 16 to achieve the combined flexible sanding composite 18 having a desired level of abrasiveness. As used herein, the term “knead” refers to any suitable manner of combining the flexible sanding composites 14 and 16 to create a combined flexible sanding composite 18 having a substantially uniform composition. As explained above, the aggressive and mild flexible sanding composites 14, 16 may each have a distinct color or shade and may be combined in various proportions to match chosen colors or shades on the color chart 26 in order to achieve desired levels of coarseness according to the color chart 26. The combined flexible sanding composite 18 can then be rubbed against the surface 24 repeatedly until the dirt or contamination 25 is diminished, or until the surface irregularities are flattened and the finish is smoothed. Either before or after rubbing the combined flexible sanding composite 18 against the surface 24, the user can add either more of the aggressive flexible sanding composite 14 or more of the mild flexible sanding composite 16 to adjust the level of coarseness of the combined flexible sanding composite 18.

As used herein, the terms “contamination” and “irregularities” are used interchangeably to refer to essentially any unwanted substance that is present on a surface. For example, the contamination may be in the form of dirt, markings, rust, paint or other coating layers, adhesive substances, or the like. Similarly, the irregularities may be in the form of dirt, markings, rust, paint or other coating layers, adhesive substances, or the like that protrude above a portion of the surface.

The combined flexible sanding composite 18 can also be used to wet-sand a vehicle or other surface. Wet-sanding can be carried out by applying a lubricant, namely an aqueous-based lubricant, to the surface prior to rubbing the surface with the combined flexible sanding composite 18. One example of a commercially-available lubricant is Clay Lube®, available from ITW/Auto Wax of Dallas, Tex.

The following examples illustrate various embodiments of the customizable clay sanding kit 10.

### EXAMPLE 1

In this example, the aggressive flexible sanding composite 14 was formed of 16.40 wt % liquid component, 81.99 wt % abrasive material, 1.13 wt % synthetic rubber, and 0.48 wt % color pigment, and the mild flexible sanding composite 16 was formed of 21.83 wt % liquid component, 74.16 wt % abrasive material, 1.13 wt % synthetic rubber, and 0.48 wt % color pigment.

A more specific breakdown of the aggressive flexible sanding composite 14 is provided in Table 1:

TABLE 1
Composition of Aggressive Clay in Example 1

| Commercial Name | Manufacturer | Category | Description | Wt % |
|---|---|---|---|---|
| Emersol ® 213 | Cognis | Liquid | Oleic Acid | 8.00 |
| Indopol ® H-100 | INEOS | Liquid | Polybutene | 4.40 |
| Indopol ® H-18,000 | INEOS | Liquid | Polybutene | 4.00 |
| Gamaco ® | Imerys | Abrasive | Calcium Carbonate | 14.69 |
| Piqua Limestone 70 | Piqua Materials | Abrasive | Calcium Carbonate | 23.00 |
| Vantalc ® F-2504 | R. T. Vanderbilt Co. | Abrasive | Calcium Carbonate | 11.00 |
| Vicron ® 41-8 | Minerals Tech. | Abrasive | Calcium Carbonate | 32.14 |
| P815/816 | Sawamura | Abrasive | Aluminum Oxide | 0.00 |
| BHA | Penta Manufacturing | Abrasive | Antioxidant | 0.04 |
| Aluminum Stearate | Ferro | Abrasive | Mold Release | 1.12 |
| Kalar ® 5246 | Royal Elastomers | Rubber | Rubber | 1.13 |
| TiO₂ | DuPont | Pigment | Pigment | 0.48 |
| Graphthol Blue BBL | Pylam Products | Pigment | Pigment | 0.004 |

The abrasive material in the aggressive flexible sanding composite 14 had an average particle size of about 15-50 micrometers. As a result of the concentration of abrasive material and average particle size, this aggressive flexible sanding composite 14 had a coarseness of about 600-800 grit.

A more specific breakdown of the mild flexible sanding composite 16 is provided in Table 2:

TABLE 2
Composition of Mild Clay in Example 1

| Commercial Name | Manufacturer | Category | Description | Wt % |
|---|---|---|---|---|
| Emersol ® 213 | Cognis | Liquid | Oleic Acid | 10.86 |
| Indopol ® H-100 | INEOS | Liquid | Polybutene | 6.08 |
| Indopol ® H-18,000 | INEOS | Liquid | Polybutene | 4.89 |
| Gamaco ® | Imerys | Abrasive | Calcium Carbonate | 0.00 |
| Piqua Limestone 70 | Piqua Materials | Abrasive | Calcium Carbonate | 19.00 |
| Vantalc ® F-2504 | R. T. Vanderbilt Co. | Abrasive | Calcium Carbonate | 9.00 |
| Vicron ® 41-8 | Minerals Tech. | Abrasive | Calcium Carbonate | 30.00 |
| P815/816 | Sawamura | Abrasive | Aluminum Oxide | 15.00 |
| BHA | Penta Manufacturing | Abrasive | Antioxidant | 0.04 |
| Aluminum Stearate | Ferro | Abrasive | Mold Release | 1.12 |
| Kalar ® 5246 | Royal Elastomers | Rubber | Rubber | 1.13 |
| TiO₂ | DuPont | Pigment | Pigment | 0.48 |
| Graphthol Blue BBL | Pylam Products | Pigment | Pigment | 0.00 |

The abrasive material in the mild flexible sanding composite 16 had an average particle size of about 0-30 micrometers. As a result of the concentration of abrasive material and average particle size, this mild flexible sanding composite 16 had a coarseness of about 1,200-1,500 grit.

A piece of the aggressive flexible sanding composite 14 was kneaded together with a piece of the mild flexible sanding composite 16 in a ratio of 1:1 to form a combined flexible sanding composite 18 having a coarseness of about 800-1,200 grit.

### EXAMPLE 2

In this example, the aggressive flexible sanding composite 14 was formed of 20.83 wt % liquid component, 77.56 wt % abrasive material, 1.13 wt % synthetic rubber, and 0.48 wt % color pigment, and the mild flexible sanding composite 16 was formed of 21.97 wt % liquid component, 76.42 wt % abrasive material, 1.13 wt % synthetic rubber, and 0.48 wt % color pigment.

A more specific breakdown of the aggressive flexible sanding composite 14 is provided in Table 3:

TABLE 3
Composition of Aggressive Clay in Example 2

| Commercial Name | Manufacturer | Category | Description | Wt % |
|---|---|---|---|---|
| Emersol ® 213 | Cognis | Liquid | Oleic Acid | 10.86 |
| Indopol ® H-100 | INEOS | Liquid | Polybutene | 5.44 |
| Indopol ® H-18,000 | INEOS | Liquid | Polybutene | 4.53 |
| Gamaco ® | Imerys | Abrasive | Calcium Carbonate | 10.69 |
| Piqua Limestone 70 | Piqua Materials | Abrasive | Calcium Carbonate | 21.91 |
| Vantalc ® F-2504 | R. T. Vanderbilt Co. | Abrasive | Calcium Carbonate | 9.79 |
| Vicron ® 41-8 | Minerals Tech. | Abrasive | Calcium Carbonate | 32.14 |
| P815/816 | Sawamura | Abrasive | Aluminum Oxide | 1.87 |
| BHA | Penta Manufacturing | Abrasive | Antioxidant | 0.04 |
| Aluminum Stearate | Ferro | Abrasive | Mold Release | 1.12 |
| Kalar ® 5246 | Royal Elastomers | Rubber | Rubber | 1.13 |
| TiO₂ | DuPont | Pigment | Pigment | 0.48 |
| Graphthol Blue BBL | Pylam Products | Pigment | Pigment | 0.004 |

The abrasive material in the aggressive flexible sanding composite 14 had an average particle size of about 10-50 micrometers. As a result of the concentration of abrasive material and average particle size, this aggressive flexible sanding composite 14 had a coarseness of about 800-1,000 grit.

A more specific breakdown of the mild flexible sanding composite 16 is provided in Table 4:

TABLE 4
Composition of Mild Clay in Example 2

| Commercial Name | Manufacturer | Category | Description | Wt % |
|---|---|---|---|---|
| Emersol ® 213 | Cognis | Liquid | Oleic Acid | 12.00 |
| Indopol ® H-100 | INEOS | Liquid | Polybutene | 6.20 |
| Indopol ® H-18,000 | INEOS | Liquid | Polybutene | 3.77 |
| Gamaco ® | Imerys | Abrasive | Calcium Carbonate | 0.00 |
| Piqua Limestone 70 | Piqua Materials | Abrasive | Calcium Carbonate | 17.00 |
| Vantalc ® F-2504 | R. T. Vanderbilt Co. | Abrasive | Calcium Carbonate | 6.26 |
| Vicron ® 41-8 | Minerals Tech. | Abrasive | Calcium Carbonate | 30.00 |
| P815/816 | Sawamura | Abrasive | Aluminum Oxide | 22.00 |
| BHA | Penta Manufacturing | Abrasive | Antioxidant | 0.04 |
| Aluminum Stearate | Ferro | Abrasive | Mold Release | 1.12 |
| Kalar ® 5246 | Royal Elastomers | Rubber | Rubber | 1.13 |
| TiO₂ | DuPont | Pigment | Pigment | 0.48 |
| Graphthol Blue BBL | Pylam Products | Pigment | Pigment | 0.00 |

The abrasive material in the mild flexible sanding composite 16 had an average particle size of about 0-20 micrometers. As a result of the concentration of abrasive material and average particle size, this mild flexible sanding composite 16 had a coarseness of about 2,000-2,500 grit.

A piece of the aggressive flexible sanding composite 14 was kneaded together with a piece of the mild flexible sanding composite 16 in a ratio of 1:1 to form a combined flexible sanding composite 18 having a coarseness of about 1,000-2,200 grit.

It should be understood that various changes and modifications to the preferred embodiments described herein would be apparent to those skilled in the art. Such changes and 13 modifications can be made without departing from the spirit and scope of the present invention and without demising its attendant advantages. It is therefore intended that such changes and modifications be covered by the appended claims

What is claimed is:

1. A customizable sanding clay kit comprising:
an aggressive flexible sanding composite that includes:
about 10% to about 70% by weight liquid component;
about 30% to about 85% by weight abrasive material; and
about 0% to about 5% by weight synthetic rubber; and
a mild flexible sanding composite that includes:
about 10% to about 80% by weight liquid component;
about 0% to about 80% by weight abrasive material; and
about 0% to about 5% by weight synthetic rubber.

2. The customizable sanding clay kit of claim 1, wherein the aggressive flexible sanding composite is a first color and the mild flexible sanding composite is a second color, and the kit further comprises a color chart having colors including the first color, at least one color resulting from a combination of the first color and the second color, and the second color, and indicating at least one level of coarseness associated with each color.

3. The customizable sanding clay kit of claim 1, wherein the aggressive flexible sanding composite has a level of coarseness approximately equal to a sandpaper grit of between about 600 and about 800.

4. The customizable sanding clay kit of claim 1, wherein the mild flexible sanding composite has a level of coarseness approximately equal to a sandpaper grit of between about 2,000 and about 2,500.

5. The customizable sanding clay kit of claim 1, wherein the liquid component of the aggressive flexible sanding composite comprises at least one of polybutene and oleic acid.

6. The customizable sanding clay kit of claim 1, wherein the liquid component of the mild flexible sanding composite at least one of polybutene and oleic acid.

7. The customizable sanding clay kit of claim 1, wherein the abrasive material of the aggressive flexible sanding composite comprises at least one of calcium carbonate and aluminum oxide.

8. The customizable sanding clay kit of claim 1, wherein the abrasive material of the aggressive flexible sanding composite has an average particle size between about 10 and about 50 micrometers.

9. The customizable sanding clay kit of claim 1, wherein the abrasive material of the mild flexible sanding composite has an average particle size between about 0 and about 30 micrometers.

10. The customizable sanding clay kit of claim 1, wherein the synthetic rubber of the aggressive flexible sanding composite comprises at least one of the group consisting of butyl rubber, cross-linked butyl rubber, and combinations thereof.

11. A customizable sanding clay kit comprising:
an aggressive flexible sanding composite having a level of coarseness approximately equal to sandpaper grit of between about 600 and about 800; and
a mild flexible sanding composite having a level of coarseness approximately equal to sandpaper grit of between about 2,000 and about 2,500.

12. The customizable sanding clay kit of claim 11, wherein the aggressive flexible sanding composite and the mild flexible sanding composite are separate clay-type materials provided in a single package.

13. The customizable sanding clay kit of claim 12, wherein the aggressive flexible sanding composite is a first color and the mild flexible sanding composite is a second color, and the package further comprises a color chart having colors including the first color, at least one color resulting from a combination of the first color and the second color, and the second color, and indicating at least one level of coarseness associated with each color.

14. A method of removing dirt or contamination from a surface, or flattening surface irregularities, comprising:
selecting an amount of an aggressive flexible sanding composite having a level of coarseness approximately equal to sandpaper grit of between about 600 and about 800;
selecting an amount of a mild flexible sanding composite having a level of coarseness approximately equal to sandpaper grit of between about 2,000 and about 2,500;
kneading together the selected amount of the aggressive flexible sanding composite with the selected amount of the mild flexible sanding composite to achieve a combined flexible sanding composite;
rubbing the combined flexible sanding composite against the surface repeatedly until the dirt or contamination is diminished, or until the surface irregularities are flattened.

15. The method of claim 14, further comprising adding more of the aggressive flexible sanding composite to the combined flexible sanding composite.

16. The method of claim 14, further comprising adding more of the mild flexible sanding composite to the combined flexible sanding composite.

17. The method of claim 14, wherein the aggressive flexible sanding composite is a first color, the mild flexible sanding composite is a second color, and the flexible sanding composites are provided in a kit containing a color chart indicating colors associated with levels of coarseness, and further comprising adjusting the selected amounts of the aggressive flexible sanding composite and the mild flexible sanding composite to achieve the combined flexible sanding composite having a color that corresponds to a desired level of coarseness.

18. The method of claim 14, wherein
the aggressive flexible sanding composite includes:
about 10% to about 70% by weight liquid component;
about 30% to about 85% by weight abrasive material; and
about 0% to about 5% by weight synthetic rubber; and
the mild flexible sanding composite includes:
about 10% to about 80% by weight liquid component;
about 0% to about 80% by weight abrasive material; and
about 0% to about 5% by weight synthetic rubber.
